(19) United States
(12) Patent Application Publication
(10) Pub. No.: US 2023/0226616 A1
(43) Pub. Date: Jul. 20, 2023

(54) MANUFACTURING METHOD OF VEHICLE WHEEL

(71) Applicant: CENTRAL MOTOR WHEEL CO., LTD., Anjo-shi (JP)

(72) Inventor: Motohiko Shinba, Okazaki-shi (JP)

(73) Assignee: CENTRAL MOTOR WHEEL CO., LTD., Anjo-shi (JP)

(21) Appl. No.: 18/078,221

(22) Filed: Dec. 9, 2022

(30) Foreign Application Priority Data
Jan. 20, 2022 (JP) 2022-006798

(51) Int. Cl. B23B 5/28

(52) U.S. Cl. CPC B23B 5/28; B23B 2215/08

(57) ABSTRACT

A manufacturing method of a vehicle wheel includes forming, on a front surface of the vehicle wheel, a cutting surface having a contour shape following a target contour shape that defines the shift of a target position in the axial direction relative to a position in the radial direction. The target contour shape includes an arcuate first fillet portion, a linear first flat portion, and a recess-projection portion having a recess-projection shape in which recessed portions and projection portions are provided alternately. The width of the first flat portion in the radial direction is equal to or more than twice the amount of feed per rotation in the lathe turning but equal to or less than a first predetermined distance.

### CROSS-REFERENCE TO RELATED APPLICATION

This application claims priority to Japanese Patent Application No. 2022-006798 filed on Jan. 20, 2022, incorporated herein by reference in its entirety.

### BACKGROUND

### 1. Technical Field

The present disclosure relates to a manufacturing method of a vehicle wheel.

### 2. Description of Related Art

As for a vehicle wheel, there has been known a technology to perform machining on a front surface (hereinafter referred to as a “front surface”) in an axial direction after molding so as to improve the aesthetic feature of the front surface (for example, see EP Patent Application Publication No. 3225335). In a vehicle wheel described in EP Patent Application Publication No. 3225335, lathe turning is performed on the front surface. The lathe turning is performed along a target contour shape that defines the shift of an axial target position relative to a radial position, and the lathe turning is performed at a feed speed at which radially adjacent cutting marks are radially connected to each other. As a result, a cutting surface having a contour shape along the target contour shape is formed on the front surface of the vehicle wheel.

### SUMMARY

In the vehicle wheel described in EP Patent Application Publication No. 3225335, the target contour shape used in the lathe turning is constituted by a recess-projection portion having a recess-projection shape in which recessed portions and projection portions are provided alternately over the whole radial area of the front surface from its radially outer end to its radially inner end. As a result, the cutting surface is formed by a recess-projection surface in which recessed portions and projection portions are provided alternately over the whole radial area of the front surface. Hereby, the aesthetic feature of the front surface is improved.

Generally, in an inspection or the like after the manufacture of the vehicle wheel, dimension measurement is performed. At this time, part of the front surface of the vehicle wheel is used as a reference plane for the dimension measurement. The reference plane of the dimension measurement is required to be a flat surface. In the vehicle wheel described in EP Patent Application Publication No. 3225335, the shape of the recess-projection surface is constituted by a linear inclined surface, and a radial width (a distance between a recess and a projection) on the inclined surface is in a range from 5 mm to 20 mm. Accordingly, it is considered that the flat surface necessary as the reference plane for the dimension measurement is easily secured on the recess-projection surface. However, when the recess-projection shape is formed to have an arcuate shape or the distance between a recess and a projection is narrowed so as to change the aesthetic feature of the front surface, it is difficult to secure, on the recess-projection surface, the flat surface necessary as the reference plane for the dimension measurement. Further, when, in consideration of the aesthetic feature, the recess-projection surface is to be also formed in the radially outer end or the radially inner end of the front surface, it is difficult to secure, on the front surface of the vehicle wheel, the flat surface necessary as the reference plane for the dimension measurement.

The present disclosure provides a manufacturing method of a vehicle wheel which can improve an aesthetic feature by providing a cutting surface having a recess-projection shape on a front surface and which can restrain a decrease in the aesthetic feature and secure a reference plane be used to measure a dimension.

An aspect of the present disclosure provides a manufacturing method of a vehicle wheel. The manufacturing method includes forming, on a front surface of the vehicle wheel, a cutting surface having a contour shape following a target contour shape that defines shift of a target position in an axial direction of the vehicle wheel relative to a position in a radial direction of the vehicle wheel, by performing lathe turning on the front surface along the target contour shape at a feed speed at which cutting marks radially adjacent to each other are radially connected to each other. The target contour shape includes: a first fillet portion having an arcuate shape and extending from a radially first side end of the front surface; a first flat portion having a linear shape and connected to a radially second side of the first fillet portion; and a recess-projection portion connected to a radially second side of the first flat portion and having a recess-projection shape in which recessed portions and projection portions are provided alternately. The width of the first flat portion in the radial direction is equal to or more than twice an amount of feed per rotation in the lathe turning but equal to or less than a first predetermined distance. The first predetermined distance is either a distance between the recessed portions radially adjacent to each other or a distance between the projection portions radially adjacent to each other.

In the above configuration, the cutting surface formed on the front surface of the vehicle wheel includes a recess-projection surface formed to correspond to the recess-projection portion of the target contour shape. Due to the recess-projection surface, the aesthetic feature of the front surface is improved. Further, the cutting surface formed on the front surface of the vehicle wheel includes a first flat surface formed to correspond to the first flat portion of the target contour shape, and the first flat surface is formed in the vicinity of a radially first side end of the cutting surface. The width of the first flat surface in the radial direction is equal to or more than twice the amount of feed per rotation in the lathe turning (hereinafter just referred to as the amount of feed) but equal to or less than the distance between radially adjacent recessed portions or between radially adjacent projection portions on the recess-projection surface. Note that, strictly speaking, on the first flat surface and the recess-projection surface, a “minute recess-projection shape formed by cutting marks” in which cutting marks each having a shape corresponding to the edge shape of a tool (a cutting tool) to be used in the lathe turning are arranged in the radial direction at the same distance as the amount of feed is formed to overlap with the target contour shape.

In the first place, it can be said that the first flat surface has a surface shape that easily secures a flat surface necessary as a reference plane for dimension measurement, in comparison with the recess-projection surface. Particularly, in a case where the shape of each of the recessed portions and the projection portions constituting the recess-projection portion is an arcuate shape, it is difficult for the recess-projection surface to secure a flat surface necessary as the reference plane for the dimension measurement. In addition, since the width of the first flat surface in the radial direction is equal to or more than twice the amount of feed, two or more projection portions in the “minute recess-projection shape formed by cutting marks” are present in the radial direction over the whole circumferential area of the first flat surface. As a result, the first flat surface secures a flat surface necessary as the reference plane for the dimension measurement. Further, since the width of the first flat surface is equal to or less than the distance between radially adjacent recessed portions or between radially adjacent projection portions on the recess-projection surface, it is possible to restrain such a situation that the aesthetic feature of the front surface decreases because the width of the first flat surface is too large. Hereby, with the above configuration, it is possible to manufacture a vehicle wheel which can improve the aesthetic feature by providing the cutting surface having a recess-projection shape on the front surface and which can restrain a decrease in the aesthetic feature and secure a reference plane to be used to measure a dimension.

In the manufacturing method, the target contour shape may further include: a second flat portion having a linear shape and connected to a radially second side of the recess-projection portion; and a second fillet portion having an arcuate shape and connected to a radially second side of the second flat portion, the second fillet portion extending to a radially second side end of the front surface. The width of the second flat portion in the radial direction may be equal to or more than twice the amount of feed per rotation in the lathe turning but equal to or less than the first predetermined distance.

In the above configuration, the cutting surface formed on the front surface of the vehicle wheel includes a second flat surface to be formed to correspond to the second flat portion of the target contour shape, and the second flat surface is formed in the vicinity of a radially second side end of the cutting surface. Note that, strictly speaking, a “minute recess-projection shape by cutting marks” is also formed on the second flat surface so as to overlap with the target contour shape, similarly to the first flat surface. The second flat surface secures a flat surface necessary as the reference plane for the dimension measurement, similarly to the first flat surface. Accordingly, the reference plane to be used to measure the dimension of each part based on the cutting surface can be easily secured in either end part of the cutting surface in the radial direction, thereby making it possible to more easily measure the dimension of each part.

In the manufacturing method, at least either of the following conditions i) and ii) may be satisfied: i) the width of the first flat portion in the radial direction is equal to or less than a second predetermined distance, the second predetermined distance being either a distance between the recessed portions radially adjacent to each other and connected to the first flat portion or a distance between the projection portions radially adjacent to each other and connected to the first flat portion; and ii) the width of the second flat portion in the radial direction is equal to or less than a third predetermined distance, the third predetermined distance being either a distance between the recessed portions radially adjacent to each other and connected to the second flat portion or a distance between the projection portions radially adjacent to each other and connected to the second flat portion.

In the manufacturing method, each of the recessed portions and the projection portions constituting the recess-projection portion may have an arcuate shape.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a front view of a vehicle wheel according to an embodiment of the present disclosure;

FIG. 2 is a drawing of a longitudinal section of the vehicle wheel illustrated in FIG. 1; and

FIG. 3 is a view illustrating an example of a target contour shape to be used in lathe turning.

### DETAILED DESCRIPTION OF EMBODIMENTS

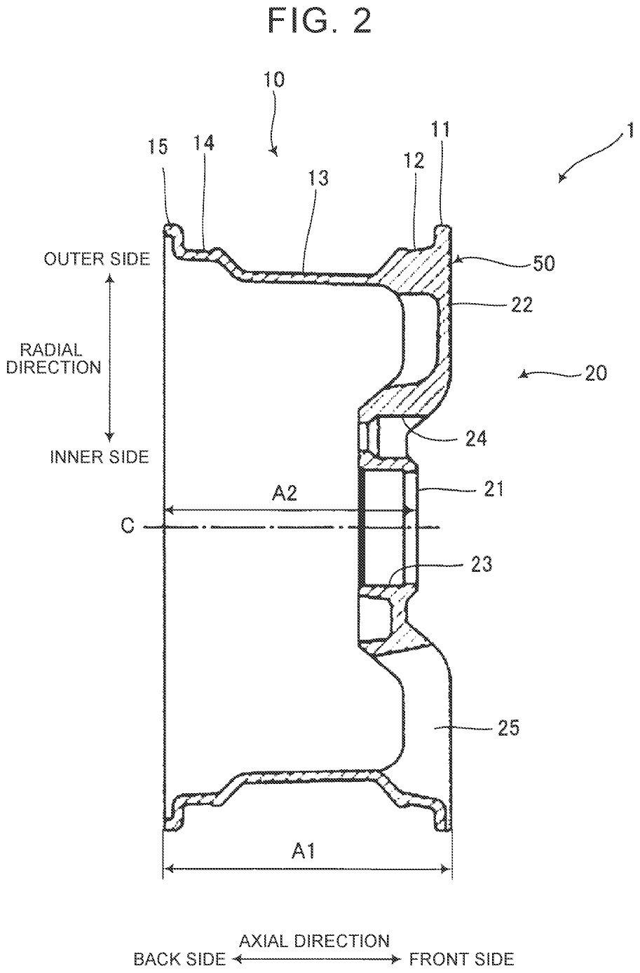

The following describes a vehicle wheel 1 according to an embodiment of the present disclosure and a manufacturing method of the vehicle wheel 1 with reference to the accompanying drawings. For convenience of description, the axial direction of the vehicle wheel 1, the radial direction of the vehicle wheel 1, are the circumferential direction of the vehicle wheel 1 are referred to as the “axial direction,” the “radial direction,” and the “circumferential direction,” respectively. Further, an “outer side” and an “inner side” in the radial direction and a “front side” and a “back side” in the axial direction are defined as illustrated in FIG. 2. The axial direction is a direction along a central axis C (see FIG. 2) of the vehicle wheel 1, the front side in the axial direction corresponds to a side of the vehicle wheel 1 that is visible from outside a vehicle when the vehicle wheel 1 is attached to the vehicle, and the back side in the axial direction corresponds to the opposite side from the side visible from outside the vehicle.

### Overall Configuration

The vehicle wheel 1 is a wheel made of light alloy. In the present embodiment, the vehicle wheel 1 is made of aluminum alloy and is manufactured by casting, for example. The vehicle wheel 1 includes a cylindrical rim portion 10 and a disc-shaped disc portion 20 provided integrally with an end portion of the rim portion 10 on the front side in the axial direction.

The rim portion 10 includes a front-side rim flange 11, a front-side bead seat 12, a drop well 13, a back-side bead seat 14, and a back-side rim flange 15 sequentially from the front side in the axial direction toward the back side in the axial direction. A bead portion of a tire (not illustrated) put on to the vehicle wheel 1 is placed on the front-side bead seat 12 and the back-side bead seat 14 and held by the front-side rim flange 11 and the back-side rim flange 15. The drop well 13 is a recessed portion in which the bead portion of the tire temporarily enters in the course of attaching the tire to the vehicle wheel 1.

The disc portion 20 includes a hub attachment portion 21 placed coaxially with the central axis C, and a plurality of spoke portions 22 extending outwardly in the radial direction from the hub attachment portion 21 to the rim portion 10 (the front-side rim flange 11) in a radial manner. The hub attachment portion 21 has a hub hole 23 penetrating in the axial direction and a plurality of bolt holes 24 provided around the hub hole 23. The vehicle wheel 1 is attached to the vehicle such that the hub attachment portion 21 is attached to a hub of an axle of the vehicle. A plurality of openings 25 penetrating in the axial direction is provided between the spoke portions 22.

### Configuration of Front Surface

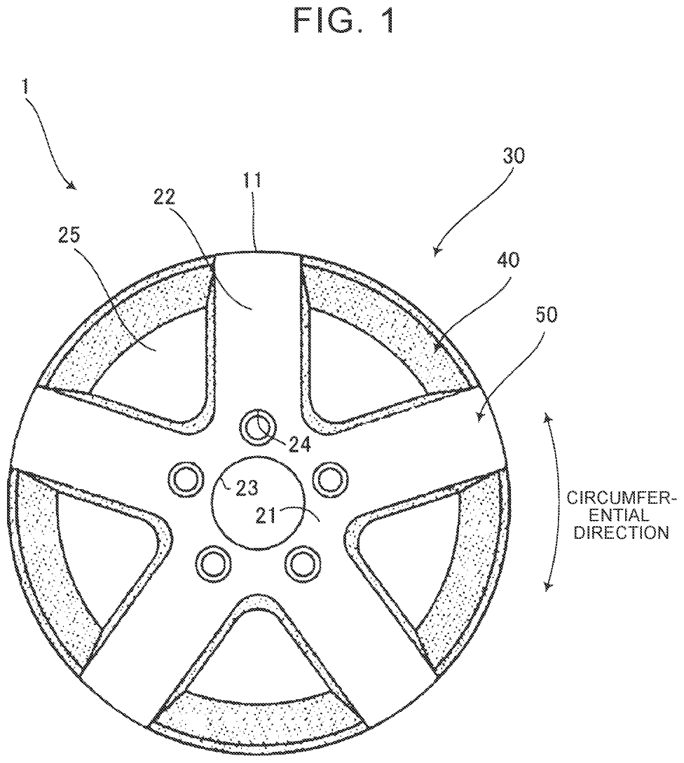

A front surface 30 (see FIG. 1) that is a surface of the vehicle wheel 1 on the front side in the axial direction is a part visible from outside the vehicle and is a part that determines the outward appearance of the vehicle wheel 1. The front surface 30 is constituted by a surface of the rim portion 10 on the front side in the axial direction and a surface of the disc portion 20 on the front side in the axial direction.

The front surface 30 has a coating surface 40 and a cutting surface 50 as illustrated in FIG. 1. Colorless or colored clear coating is applied on the whole surface of the vehicle wheel 1. On this account, the coating surface 40 and the cutting surface 50 are visible through a clear coating film. Note that the clear coating film is not illustrated in all the drawings.

The coating surface 40 is a surface in which colored coating is applied to a casting surface after molding. In FIG. 1, the coating surface 40 is illustrated by a dotted pattern. In the vehicle wheel 1, a part of the front surface 30 other than the cutting surface 50 corresponds to the coating surface 40.

The cutting surface 50 is a metal glory surface obtained by removing, by lathe turning, part of the casting surface subjected to the coating together with a coating film. The cutting surface 50 is made brighter by comparison with the coating surface 40. As seen from FIG. 1, in the vehicle wheel 1, the cutting surface 50 is formed continuously in the radial direction from a radially outer end of the front-side rim flange 11 of the rim portion 10 to a hole edge of the hub hole 23 via the spoke portions 22 and the hub attachment portion 21 of the disc portion 20 (that is, over the whole area of the front surface 30 in the radial direction). A detailed shape of the cutting surface 50 will be described later.

### Manufacturing Method

The vehicle wheel 1 is manufactured by sequentially performing a casting step, a machining step, a coating step, a lathe turning step, and a final coating step. In the casting step, a rough shape of the vehicle wheel 1 is formed by casting. In the machining step, the rim portion 10 and the hub hole 23, the bolt holes 24, and so on in the disc portion 20 are formed by cutting or the like, for example. In the coating step, the coating surface 40 is formed by applying coating to the whole. In the lathe turning step, lathe turning is performed on the front surface 30 so as to form the cutting surface 50 such that part of a casting surface (that is, the coating surface 40) after the coating is subjected to cutting together with a coating film (to be described later in detail). In the final coating step, clear coating is performed.

### Lathe Turning Step

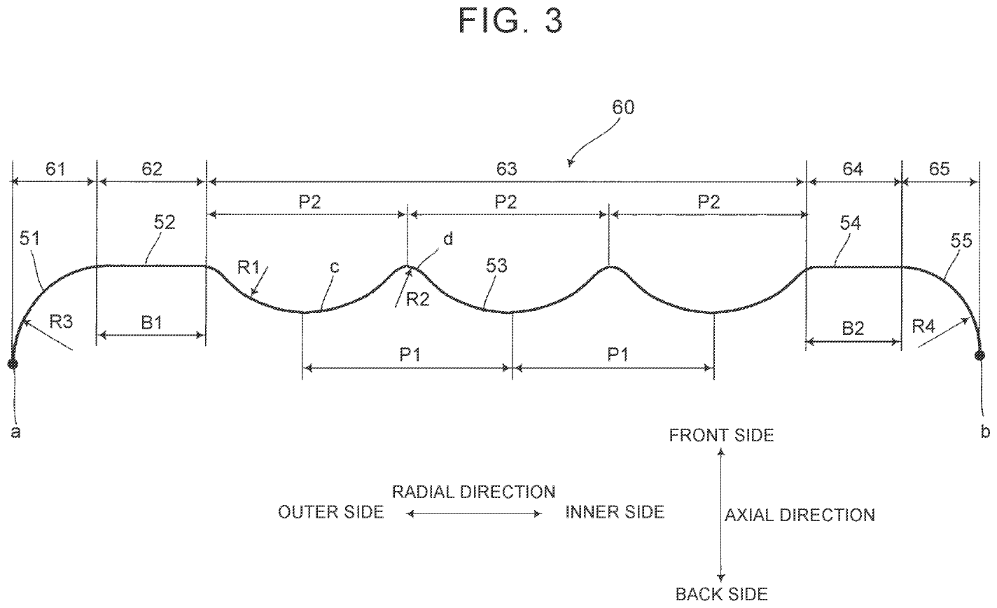

The following describes the lathe turning step in detail. In the lathe turning step, the cutting surface 50 continuous in the radial direction is formed over the whole area of the front surface 30 in the radial direction by lathe turning. The lathe turning is performed along a target contour shape 60 illustrated in FIG. 3 at a feed speed at which cutting marks adjacent to each other in the radial direction are connected to each other in the radial direction. The target contour shape 60 is a shape defining the shift of a target position in the axial direction relative to the position of the cutting surface 50 in the radial direction on the longitudinal section of the vehicle wheel 1 and is equal to the contour shape of the cutting surface 50.

More specifically, as illustrated in FIG. 3, the target contour shape 60 has a first fillet portion 61, a first flat portion 62, a recess-projection portion 63, a second flat portion 64, and a second fillet portion 65 sequentially along the radial direction so as to form the cutting surface 50 from a radially outer end a of the front-side rim flange 11 of the rim portion 10 to a hole edge b of the hub hole 23 via the spoke portion 22 and the hub attachment portion 21 of the disc portion 20.

The first fillet portion 61 is an arcuate part extending from the radially outer end a of the front-side rim flange 11 of the rim portion 10 and is a part at which a front-side end part of the front-side rim flange 11 is chamfered. The first flat portion 62 is a part connected to a radially inner side of the first fillet portion 61 and is a part linearly extending parallel to the radial direction. The recess-projection portion 63 is a part connected to a radially inner side of the first flat portion 62 and is a part having a recess-projection shape in which recessed portions c and projection portions d are provided alternately. The shape of each of the recessed portions c and the projection portions d constituting the recess-projection portion 63 is an arcuate shape. The second flat portion 64 is a part connected to a radially inner side of the recess-projection portion 63 and linearly extending parallel to the radial direction. The second fillet portion 65 is an arcuate-shaped part connected to a radially inner side of the second flat portion 64 and extending to the hole edge b of the hub hole 23 and is a part at which a front-side end part of the hub hole 23 is chamfered.

The first fillet portion 61 and the first flat portion 62 are placed in a radially outer end part of the target contour shape 60, the second fillet portion 65 and the second flat portion 64 are placed in a radially inner end part of the target contour shape 60, and the recess-projection portion 63 constitutes a most part of the target contour shape 60 other than both ends of the target contour shape 60 in the radial direction. In FIG. 3, in the recess-projection portion 63, three recessed portions c are aligned in the radial direction, but in practice, more than three recessed portions c are aligned along the shape of the cutting surface 50.

In the lathe turning, for example, an arcuate-shaped cutting tool with an edge shape having a radius of 2 mm is used, and the feed speed of the cutting tool is set to be uniform at 0.4 mm/rotation. Hereby, the feed speed of the cutting tool is a speed at which radially adjacent cutting marks made by the cutting tool are connected to each other in the radial direction.

A radius R3 of the arcuate shape of the first fillet portion 61 is, for example, 2.5 mm, and a radius R4 of the arcuate shape of the second fillet portion 65 is, for example, 1.0 mm. In the recess-projection portion 63, a distance P1 between radially adjacent recessed portions c (=a distance P2 between radially adjacent projection portions d) is, for example, 2.2 mm, a radius R1 of the arcuate shape of the recessed portion c is, for example, 3.0 mm, and a radius R2 of the arcuate shape of the projection portion d is, for example, 1.0 mm. In the present embodiment, the distance P1 (=the distance P2) is uniform without depending on the position in the radial direction.

Each of a width B1 of the first flat portion 62 in the radial direction and a width B2 of the second flat portion 64 in the radial direction is set to be equal to or more than twice the amount of feed (=0.4 mm) per rotation in the lathe turning but equal to or less than the distance P1 between radially adjacent recessed portions c (=the distance P2 between radially adjacent projection portions d). More specifically, each of the width B1 and the width B2 is equal to or more than 0.8 mm but equal to or less than 2.2 mm.

In the lathe turning, the vehicle wheel 1 is rotated, the cutting depth of the cutting tool at the radial position of the cutting tool is adjusted such that the contour shape of the cutting surface 50 on the longitudinal section of the vehicle wheel 1 follows the shape of the target contour shape 60, and the front surface 30 is cut continuously from the radially outer end a of the front-side rim flange 11 of the rim portion 10 to the hole edge b of the hub hole 23 while the cutting tool is moved in the radial direction at the feed speed. Hereby, spiral cutting marks (cutting grooves) made by the cutting tool are formed such that the spiral cutting marks are connected to each other in the radial direction, and thus the cutting surface 50 is formed.

As a result, as illustrated in FIG. 3, the cutting surface 50 is constituted by a first fillet surface 51, a first flat surface 52, a recess-projection surface 53, a second flat surface 54, and a second fillet surface 55 so as to correspond to the first fillet portion 61, the first flat portion 62, the recess-projection portion 63, the second flat portion 64, and the second fillet portion 65 of the target contour shape 60. Note that, although not illustrated in FIG. 3, in practice, a “minute recess-projection shape formed by cutting marks” in which cutting marks (cutting grooves) each having a shape corresponding to the edge shape of the cutting tool are arranged in the radial direction at the same distance as the amount of feed per rotation are formed in an overlapped manner with the target contour shape 60 on the cutting surface 50 (=the first fillet surface 51+the first flat surface 52+the recess-projection surface 53+the second flat surface 54+the second fillet surface 55).

The recess-projection surface 53 constitutes a most part of the cutting surface 50 other than both ends of the cutting surface 50 in the radial direction. Due to the recess-projection surface 53, the aesthetic feature of the front surface 30 is improved. Further, a radially outer end part of the cutting surface 50 includes the first flat surface 52. The width B1 of the first flat surface 52 in the radial direction is equal to or more than twice the amount of feed per rotation but equal to or less than the distance between radially adjacent recessed portions c or between radially adjacent projection portions d in the recess-projection surface 53.

In the first place, the first flat surface 52 has a surface shape that easily secures a flat surface necessary as a reference plane for dimension measurement, in comparison with the recess-projection surface 53. Particularly, in the present embodiment, since the shape of each of the recessed portions c and the projection portions d constituting the recess-projection surface 53 is an arcuate shape, it is difficult for the recess-projection surface 53 to secure the flat surface necessary as the reference plane for the dimension measurement. In addition, the first flat surface 52 has a radial width equal to or more than twice the amount of feed per rotation. Accordingly, two or more projection portions in the “minute recess-projection shape formed by cutting marks” are present in the radial direction over the whole circumferential area of the first flat surface 52, and the flat surface necessary as the reference plane for the dimension measurement is secured in the first flat surface 52. As a result, the first flat surface 52 is easily used as the reference plane to be used for measurement of a dimension A1 (see FIG. 2) in the vehicle wheel 1, for example, in comparison with the recess-projection surface 53. Further, since the width of the first flat surface 52 is equal to or less than the distance between radially adjacent recessed portions c or between radially adjacent projection portions d on the recess-projection surface 53, it is possible to restrain such a situation that the aesthetic feature of the front surface 30 decreases because the width of the first flat surface 52 is too large.

Similarly, a radially inner end part of the cutting surface 50 includes the second flat surface 54. The width B2 of the second flat surface 54 in the radial direction is equal to or more than twice the amount of feed per rotation but equal to or less than the distance between radially adjacent recessed portions c or between radially adjacent projection portions d on the recess-projection surface 53.

In the first place, the second flat surface 54 has a surface shape that easily secures a flat surface necessary as a reference plane for dimension measurement, in comparison with the recess-projection surface 53. Particularly, in the present embodiment, since the shape of each of the recessed portions c and the projection portions d constituting the recess-projection surface 53 is an arcuate shape, it is difficult for the recess-projection surface 53 to secure the flat surface necessary as the reference plane for the dimension measurement. In addition, the second flat surface 54 has a radial width equal to or more than twice the amount of feed per rotation. Accordingly, two or more projection portions in the “minute recess-projection shape formed by cutting marks” are present in the radial direction over the whole circumferential area of the second flat surface 54, and the flat surface necessary as the reference plane for the dimension measurement is secured in the second flat surface 54. As a result, the second flat surface 54 is easily used as the reference plane to be used for measurement of a dimension A2 (see FIG. 2) in the vehicle wheel 1, for example, in comparison with the recess-projection surface 53. Further, since the width of the second flat surface 54 is equal to or less than the distance between radially adjacent recessed portions c or between radially adjacent projection portions d on the recess-projection surface 53, it is possible to restrain such a situation that the aesthetic feature of the front surface 30 decreases because the width of the second flat surface 54 is too large.

Note that the recess-projection surface 53 connected to the first flat surface 52 (the second flat surface 54) is placed closer to the back side, in the axial direction, than the first flat surface 52 (the second flat surface 54). Accordingly, the first flat surface 52 (the second flat surface 54) serves as a part projecting toward the front side in the axial direction from the recess-projection surface 53, so that the first flat surface 52 (the second flat surface 54) is easily used as the reference plane to be used for the dimension measurement in the vehicle wheel 1.

### Operations and Effects

With the manufacturing method of the vehicle wheel 1 according to the present embodiment, the cutting surface 50 formed on the front surface 30 of the vehicle wheel 1 includes the recess-projection surface 53 formed to correspond to the recess-projection portion 63 of the target contour shape 60. Due to the recess-projection surface 53, the aesthetic feature of the front surface 30 is improved. Further, the radially outer end part of the cutting surface 50 formed on the front surface 30 of the vehicle wheel 1 includes the first flat surface 52 formed to correspond to the first flat portion 62 of the target contour shape 60, and the radially inner end part of the cutting surface 50 includes the second flat surface 54 formed to correspond to the second flat portion 64 of the target contour shape 60. The widths B1, B2 of the first and second flat surfaces 52, 54 in the radial direction are equal to or more than twice the amount of feed per rotation in the lathe turning but equal to or less than the distance between radially adjacent recessed portions c or radially adjacent projection portions d on the recess-projection surface 53. Strictly speaking, on the first and second flat surfaces 52, 54 and the recess-projection surface 53, the “minute recess-projection shape formed by cutting marks” in which cutting marks each having a shape corresponding to the edge shape of a tool (the cutting tool) to be used in the lathe turning are arranged in the radial direction at the same distance as the amount of feed are formed to overlap with the target contour shape 60.

In the first place, it can be said that the first and second flat surfaces 52, 54 have a surface shape that easily secures a flat surface necessary as the reference plane for dimension measurement. Particularly, in the present embodiment, since the shape of each of the recessed portions c and the projection portions d constituting the recess-projection surface 53 is an arcuate shape, it is difficult for the recess-projection surface 53 to secure a flat surface necessary as the reference plane for the dimension measurement. In addition, the first and second flat surfaces 52, 54 have a radial width equal to or more than twice the amount of feed per rotation. Accordingly, two or more projection portions in the “minute recess-projection shape formed by cutting marks” are present in the radial direction over the whole circumferential area on the first and second flat surfaces 52, 54. As a result, the first and second flat surfaces 52, 54 secure a flat surface necessary as the reference plane for dimension measurement. Further, since the widths of the first and second flat surfaces 52, 54 are equal to or less than the distance between radially adjacent recessed portions c or between radially adjacent projection portions d on the recess-projection surface 53, it is possible to restrain such a situation that the aesthetic feature of the front surface 30 decreases because the widths of the first and second flat surfaces 52, 54 are too large.

Consequently, with the manufacturing method of the vehicle wheel 1 according to the present embodiment, it is possible to manufacture the vehicle wheel 1 which can improve the aesthetic feature by providing the cutting surface 50 having a recess-projection shape on the front surface 30 and which can restrain a decrease in the aesthetic feature and secure the reference plane to be used to measure the dimension.

The present disclosure is not limited to the above typical embodiment, and various applications and modifications are conceivable without departing from the object of the present disclosure. For example, the following modifications can be made by applying the above embodiment.

In the present embodiment, in the recess-projection portion 63 (accordingly, the recess-projection surface 53 of the cutting surface 50) of the target contour shape 60, the distance P1 between radially adjacent recessed portions c (=the distance P2 between radially adjacent projection portions d) is uniform without depending on the position in the radial direction. However, the distance P1 between radially adjacent recessed portions c (=the distance P2 between radially adjacent projection portions d) may be changed depending on the position in the radial direction. In this case, it is preferable that the width B1 of the first flat portion 62 (accordingly, the first flat surface 52) in the radial direction be equal to or less than a distance between radially adjacent recessed portions c or radially adjacent projection portions d that are connected to the first flat portion 62 (accordingly, the first flat surface 52). Similarly, it is preferable that the width B2 of the second flat portion 64 (accordingly, the second flat surface 54) in the radial direction be equal to or less than a distance between radially adjacent recessed portions c or radially adjacent projection portions d that are connected to the second flat portion 64 (accordingly, the second flat surface 54).

Further, in the present embodiment, the radially outer end part of the target contour shape 60 (accordingly, the cutting surface 50) includes the first flat portion 62 (accordingly, the first flat surface 52), and the radially inner end part of the target contour shape 60 (accordingly, the cutting surface 50) includes the second flat portion 64 (accordingly, the second flat surface 54). However, either of the first flat portion 62 (accordingly, the first flat surface 52) and the second flat portion 64 (accordingly, the second flat surface 54) may be omitted.

What is claimed is:

1. A manufacturing method of a vehicle wheel, the manufacturing method comprising forming, on a front surface of the vehicle wheel, a cutting surface having a contour shape following a target contour shape that defines shift of a target position in an axial direction of the vehicle wheel relative to a position in a radial direction of the vehicle wheel, by performing lathe turning on the front surface along the target contour shape at a feed speed at which cutting marks radially adjacent to each other are radially connected to each other, wherein:
the target contour shape includes
a first fillet portion having an arcuate shape and extending from a radially first side end of the front surface,
a first flat portion having a linear shape and connected to a radially second side of the first fillet portion, and
a recess-projection portion connected to a radially second side of the first flat portion and having a recess-projection shape in which recessed portions and projection portions are provided alternately;
a width of the first flat portion in the radial direction is equal to or more than twice an amount of feed per rotation in the lathe turning but equal to or less than a first predetermined distance; and
the first predetermined distance is either a distance between the recessed portions radially adjacent to each other or a distance between the projection portions radially adjacent to each other.

2. The manufacturing method of the vehicle wheel according to claim 1, wherein:
the target contour shape further includes
a second flat portion having a linear shape and connected to a radially second side of the recess-projection portion, and
a second fillet portion having an arcuate shape and connected to a radially second side of the second flat portion, the second fillet portion extending to a radially second side end of the front surface; and
a width of the second flat portion in the radial direction is equal to or more than twice the amount of feed per rotation in the lathe turning but equal to or less than the first predetermined distance.

3. The manufacturing method of the vehicle wheel according to claim 2, wherein at least either of a following conditions i) and ii) is satisfied:
i) a width of the first flat portion in the radial direction is equal to or less than a second predetermined distance, the second predetermined distance being either a distance between the recessed portions radially adjacent to each other and connected to the first flat portion or a distance between the projection portions radially adjacent to each other and connected to the first flat portion; and
ii) a width of the second flat portion in the radial direction is equal to or less than a third predetermined distance, the third predetermined distance being either a distance between the recessed portions radially adjacent to each other and connected to the second flat portion or a distance between the projection portions radially adjacent to each other and connected to the second flat portion.

4. The manufacturing method of the vehicle wheel according to claim 1, wherein each of the recessed portions and the projection portions constituting the recess-projection portion has an arcuate shape.
